(19) United States
(12) Patent Application Publication
(10) Pub. No.: US 2025/0284978 A1
(43) Pub. Date: Sep. 11, 2025

(54) Data Pre-Processing for Search Indexes and Machine Learning Pipelines With a Common Specification

(71) Applicant: Google LLC, Mountain View, CA (US)

(72) Inventors: Hoai Phuoc Truong, Bellevue, WA (US); Huong Thi Thu Phan, Kirkland, WA (US); Seyed Omid Fatemieh, Bellevue, WA (US); Guang Cheng, Sammamish, WA (US); Jiashang Liu, Kirkland, WA (US); Yinguang Zhao, Issaquah, WA (US); Xi Cheng, Kirkland, WA (US); Eric Hao, Seattle, WA (US)

(21) Appl. No.: 18/596,124

(22) Filed: Mar. 5, 2024

(51) Int. Cl. G06N 5/01

(52) U.S. Cl. CPC G06N 5/01

(57) ABSTRACT

Methods, systems, and apparatus, including computer-readable storage media relating to a database management system (DBMS) configured to perform data searching and machine learning (ML) pre-processing using a common user specification. Two common functions associated with large databases are searching for data in the database and using data stored in databases for data-intensive processing, such as training or executing a machine learning model. While a single DBMS may implement separate sub-systems for searching and machine learning model processing that rely on similar operations, e.g., text processing, the respective interfaces for each sub-system are different and have different requirements for properly formed user input. A specification, when parsed by either a search sub-system or ML pre-processing system, can allow for correctly pre-processing data in accordance with the specification, without the user having to provide separate specifications for either sub-system.

### BACKGROUND

A database management system manages a database and receives and resolves queries for data stored in the database. A search index is a data structure for storing a mapping from data, such as words or numbers, to its locations in a table of a database. As part of generating a search index, the DBMS may pre-process the data, for example to improve the search index generation or search and retrieval of data using the generated index. Inverted search indexes are a type of search index often used for document retrieval, partly because of their scalability in indexing and retrieving large amounts of data.

Some database management systems offer services for building and training machine learning models using data stored in databases. In machine learning, data pre-processing can refer to the manipulation, filtration, or augmentation of data before it is used in training or executing a model. Search-related sub-systems and machine learning sub-systems of a DBMS can both benefit from text pre-processing on similar data. Separate user interfaces are developed for different purposes and for each of these sub-systems. This separate development is error-prone when translating or importing certain text pre-processing functions from a search context to a machine learning pre-processing context, or vice versa. This redundancy and ambiguity can result in less efficient utilization of the DBMS, at least because of redundant requests and duplication of text pre-processing on the same target data.

### BRIEF SUMMARY

Aspects of the technology relate to a database management system (DBMS) configured to perform data searching and machine learning (ML) pre-processing using the same user specification. Two common functions associated with large databases are searching for data in the database and using data stored in databases for data-intensive processing, such as training or executing a machine learning model. While a single DBMS may implement separate sub-systems for searching and machine learning model processing that rely on similar operations, e.g., text processing, the respective interfaces for each sub-system are different and have different requirements for properly formed user input.

A specification can be included in a request or query to the DBMS. A specification can be a portion of a query statement in a structured query language (SQL), a JSON string, or other metadata associated with a request to either a search sub-system or a machine learning pre-processing sub-system. A DBMS can parse a common specification to apply relevant information, like patterns, stop words, etc., to augment machine learning pre-processing pipelines without relying on complex query statements optimized for generating or leveraging inverted search indexes. On the other hand, the DBMS implementing a common specification can still provide for a depth of parameterization or customization such that the generation of precise search indexes is not compromised.

A specification, when parsed by either a search sub-system or ML pre-processing system, can allow for correctly pre-processing data in accordance with the specification, without the user having to provide separate specifications for either sub-system. The same specification can be reused in different contexts, e.g., for search index generation, feature engineering, searching a database, etc., and also provides for a higher consistency in interactions between a user computing device and target data managed by a DBMS.

A specification can store a variety of different parameter values and conditions, to allow for advanced text pre-processing regardless of whether the specification is processed in a search or machine learning context. Fewer errors can result in fewer requests overall and improve efficiency, especially throughput for limited query quota-based systems. An interface for interacting with the machine learning pre-processing and search sub-systems is improved, as at least using the same specification results in fewer erroneous specifications from being sent overall, reducing data traffic, memory usage, and processor usage.

Aspects of the technology provide for more direct user interaction with machine learning pipeline functionalities of a DBMS. A DBMS can implement a number of different machine learning services, e.g., for pre-processing data, executing machine learning models, and/or training machine learning models. The common specification can allow for more accurate and more efficient ML pipeline execution, at least because the number of re-tries or modifications to the textual pre-processing of the ML pipeline can be reduced or eliminated.

### BRIEF DESCRIPTION OF THE DRAWINGS

FIG. 1 is a block diagram of an example database management system (DBMS) configured to process a common specification from a user computing device for both a machine learning (ML) pre-processing sub-system and a search sub-system, according to aspects of the disclosure.

FIG. 2 is a flow diagram of an example process for performing search indexing and machine learning pre-processing using the same user specification, according to aspects of the disclosure.

FIG. 3 is a block diagram of an example computing environment for implementing the database management system, according to aspects of the disclosure.

### DETAILED DESCRIPTION

Aspects of the technology relate to a database management system (DBMS) configured to perform search indexing and machine learning pre-processing using the same user specification. The user specification can be part of a request to either a machine learning pre-processing sub-system or a search sub-system. For example, the request and user specification can be a query statement in a structured query language (SQL), a JSON string, or other metadata.

The DBMS is configured to parse the specification and execute the specification depending on the context in which the system receives the specification. For example, the DBMS may implement different interfaces for receiving input intended for search indexing versus machine learning pre-processing. Depending on which interface the system receives the specification from, the DBMS can parse and process the specification in accordance with the respective sub-system corresponding to the interface.

The specification can be used as input to include calls to one or more pre-processing functions. A pre-processing function can generally relate to performing some type of operation, e.g., text pre-processing, pattern recognition, etc.

Aspects of the disclosure can provide for at least the following technical benefits. The specification forms a building block for building search indexing and machine learning pipelines separately. Both types of pipelines rely on processing a large data set, and a common specification reduces the overall number of queries that have to be made for executing both types of pipelines. Example types of operations enabled include sentiment analysis, similarity searching, clustering, and natural language translation. A DBMS executing search index and machine learning pipeline, for example as respective sub-systems, can improve query throughput for limited query quotas, and easily scales for more users and more requests to sub-systems executing either a search index or machine learning pipeline.

For example, a specification can include parameters for performing a textual analysis on a target set of data. The specification optionally sets one or more parameter values, settings, configurations, etc., for performing the textual analysis. For purposes of description, the specification can include parameter values for a textual analysis function. As an example, the specification can include parameter values for tokenizing target data, generating a Term Frequency-Inverse Document Frequency (TF-IDF), and/or generating a bag-of-words representation of the target data. These and other examples can then be automatically applied in either a search or machine learning pre-processing pipeline, without changing the format or content of the specification depending on the pipeline receiving the specification. If the DBMS receives the specification in a search context, the DBMS is configured to, for example, generate a set of tokens from the target text.

As another example, the DBMS may manage log data relating to transactions between devices on a network. The DBMS may be used to train and execute a machine learning model trained for anomaly detection, specifically detecting instances of fraud or other suspicious activity on the network using the log data. The DBMS can also tokenize data according to a common specification, for generating a search index on the log data.

A common specification unifies the user experience between different services of a DBMS that are generally developed independent of one another. Despite the commonality of both search and ML pipelines operating on large sets of data, interfaces for sub-systems implementing either pipeline are not uniform to allow for consistent pre-processing on the same set of data. Further, allowing for a common specification can ensure that data is treated the same in either pipeline, as this consistency can allow for improvement of one pipeline based on processing done on the other. For instance, ML pre-processing can be driven from observations and analyses performed on a target data set, prior to the data set being pre-processed for training a machine learning model. A common specification ensures that data that is obtained from a search query using a specific search index is pre-processed the same way when it is used for training and executing a machine learning model.

The specification can include a pattern recognition parameter value, specifying a type of pattern recognition to perform as part of executing the function call. For example, the parameter value can be a regular expression for extracting certain parts of the targeted log data, such as a unique identifier, a network or email address, or information stored in the log. The parameter value can include other types of patterns for parsing and extracting data.

The DBMS can use the specification for parsing text in accordance with the pattern and generating a search index to search log data more efficiently in the database matching the specified pattern. As part of pre-processing the targeted log data in accordance with the specification, the specification may include other parameter values, for example to lowercase the text to enable case-insensitive searching, or to remove some known or filler data in the database.

The specification can include multiple sets of parameter values. For example, a specification may define multiple regular expressions, and multiple filter values for filtering tokens created from text in accordance with the multiple regular expressions. Different stop words can also be defined in the specification, which may be shared among the different regular expression. Multiple sets of parameter values in a specification allow for rapid iteration, which may be used to identify a final specification that is more responsive for the type of searching or ML pre-processing that will use the target data.

The DBMS can generate a search index from the specification, which can be used to more accurately and efficiently parse other log data stored in the database. The DBMS can apply the pre-processing function call with the parameter values of the specification on both a target data set, as well as the input search query, and return TRUE if the tokens from the search query is a subset of the tokens from the searched data.

The same specification that results in the tokenized data can be used by a ML pre-processing sub-system implemented by the DBMS to train a machine learning model to detect anomalous activity in the log data. For example, the ML pre-processing sub-system can generate tokenized data matching the regular expression or other pattern in the specification, which was also used to generate tokens for creating a search index. The sub-system can vectorize the tokens, for example using a pre-processing function to create a bag-of-words representation of the tokenized data. The DBMS can then provide the pre-processed data as training data to a downstream ML processing pipeline, configured to train the machine learning model. For testing or processing new input data at inference, the DBMS can again use the specification to properly pre-process the input data prior to testing or processing.

The specification used for generating a search index, training a machine learning model, and testing or processing new input on the trained machine learning model is the same across all use cases, ensuring uniformity in the pre-processed data. Further, the uniformity can improve how models are trained or executed. For example, as analysis or tests are performed on queried data provided using a generated index, the use of a common specification ensures that the training data is not pre-processed differently than how the data was provided in response to search queries during a data exploration or testing phase.

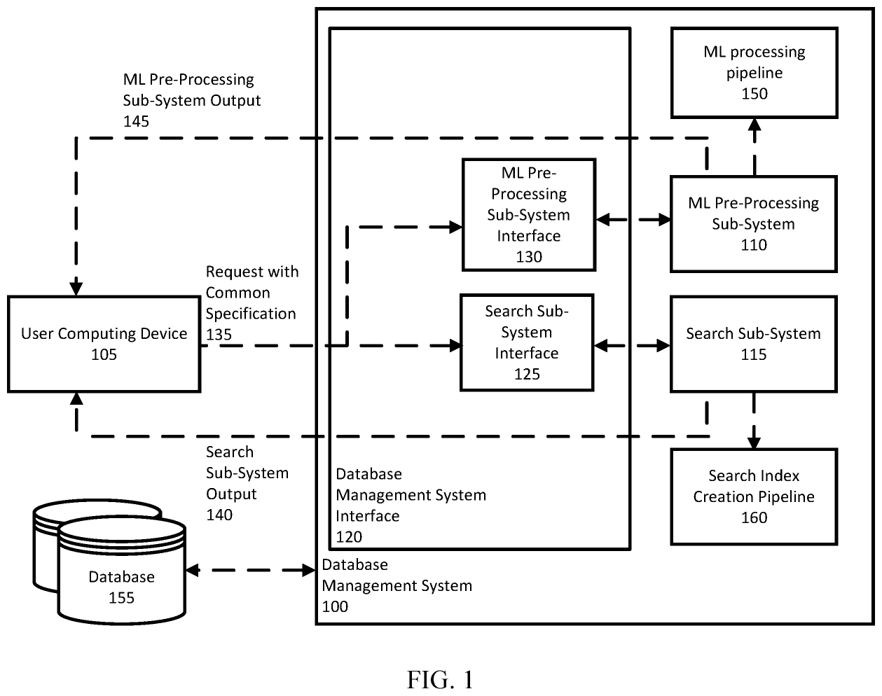

FIG. 1 is a block diagram of an example database management system (DBMS) 100 configured to process a common specification from a user computing device 105 for both a machine learning (ML) pre-processing sub-system 110 and a search sub-system 115. Data flows between example components or devices in FIG. 1, which is shown with dashed lines.

User computing device 105 can interact with the DBMS 100 through a DBMS interface 120. The DBMS 100 may implement different interfaces for receiving input intended for the search sub-system to generate a search index for a target set of data, versus a machine learning pre-processing system configured to pre-process the target set of data for training or model execution. For example, the DBMS interface 120 can further implement a search sub-system interface 125 and an ML pre-processing sub-system interface 130.

The DBMS 100 can parse a request with a common specification 135 and execute the common specification depending on the context in which the DBMS 100 receives the specification. Depending on which interface the DBMS 100 receives the common specification from, the DBMS 100 parses and processes the specification in accordance with the respective sub-system for the interface.

In some examples, the DBMS 100 determines the correct context based on the type of request the specification is a part of. For example, a specification can appear in a query statement, indicating a request for content responsive to the query after applying the specification. As another example, a specification can appear in a request to pre-process data to prepare the data for use in training a machine learning model.

The user computing device 105 can be configured, e.g., through an application programming interface (API), a web interface, a standalone computer program running entirely on the user computing device, etc., to generate a common specification. The specification can include calls to one or more pre-processing functions The pre-processing function can be indicated in the specification, e.g., as a keyword or field. Executing a pre-processing function can cause a sub-system to perform some type of operation, e.g., text pre-processing, pattern recognition, etc.

Some types of operations, e.g., searching or training a machine learning model, may require or are improved by input that has been pre-processed. For example, pre-processing can include transforming unstructured data or natural language data from the database 155 into a format suitable for downstream processes, like processes for training a machine learning model. As another example, the effectiveness of a database search index can be influenced by the quality of how text is tokenized during a pre-processing step. Similarly, the performance of machine learning models can rely heavily on the quality of pre-processed inputs.

Database 155 can store various types of data, e.g., text data, including log data, documents, source code, etc. The data stored by the database 155 can be stored across one or more physical devices in one or more physical locations. Text data stored can be structured or unstructured. Other types of data may be stored, e.g., audio data, image data, video data, etc. The DBMS 100 is configured to execute various procedures for analyzing and processing data stored in the database 155. These procedures can be implemented as pipelines, which may for example be executed by the search sub-system 115 and the ML pre-processing sub-system 110.

The specification optionally sets one or more parameter values, settings, etc., for performing the textual analysis. For purposes of description, the specification can include parameters for executing functions, such as textual analysis functions. An example function for textual analysis is described in the tables below, as a ‘TEXT.ANALYZE’ function. The DBMS 100 is configured to receive the specification in a respective context. For example, if the DBMS 100 receives the specification through an interface for a search sub-system, the DBMS 100 can process the specification and can perform one or more search-related operations, e.g., tokenizing text to generate a search index, searching a target set of data, etc. The output of performing these operations can form part of search sub-system output 140, which can be sent to the user computing device 105 in response to the request with the common specification 135.

As another example, if the DBMS 100 receives the specification through the interface 130 for the machine learning pre-processing sub-system 110, the DBMS 100 can process the specification and can perform one or more machine learning pre-processing operations, e.g., perform a text vectorization on a target set of data, which can form part of a feature engineering through the ML processing pipeline 150. The output of performing these operations can form part of the ML pre-processing sub-system output 145, which can be sent to the user computing device 105 in response to the request with the common specification 135.

In some examples and as shown in FIG. 1, the DBMS 100 can implement an ML processing pipeline 150. The ML processing pipeline 150 can be implemented on one or more devices or engines for performing machine learning tasks, described in more detail herein. Output from the ML pre-processing sub-system 110 can be sent downstream to the ML processing pipeline 150, for example as part of an end-to-end system for training or executing a machine learning model.

In some examples and as shown in FIG. 1, the DBMS may implement a search index creation pipeline 160. The pipeline 160 may be implemented on one or more devices or engines as with the ML processing pipeline 150. The output from the search sub-system can be sent downstream to the search index creation pipeline 160, for example as part of generating a search index that can be used by the search sub-system 115 to resolve search queries.

An example of a specification is shown in TABLE 1. The specification can be part of a request generated by the user computing device 105. The request may be formed as part of a standard query language (SQL) or some other formatted programming or scripting language.

TABLE 1

| | |
|---|---|
| 1 | TEXT.ANALYZE( |
| 2 | ‘O Foo Bar’, |
| 3 | specification { |
| 4 | analyzer => ‘PATTERN_ANALYZER’ |
| 5 | analyzer_options => ‘{ |
| 6 | ″patterns:″: [″\\b\\w\\w+\\b″], |
| 7 | ″stop_words″: [″foo″] |
| 8 | }’ |
| 9 | } |
| 10 | ) |

As shown in line one of TABLE 1, TEXT.ANALYZE is called, with a number of input parameters, shown in lines two through ten. Line two shows ‘O Foo Bar’ as input text, although the input text could also be through a reference to a table or portion of a database storing text data. An example specification is provided in lines three through eight. Line four specifies a ‘PATTERN_ANALYZER,’ which can be an analysis type parameter value, e.g., a pattern recognition parameter value, with reference to a pattern analysis function for analyzing text indicative of a predetermined pattern. Lines five through seven specify parameter values for the pattern analysis function. The specification can be formatted according to a JSON string or according to any other predetermined format. For example, the predetermined pattern is represented in line six, as a regular expression ‘\\b\\w\\w+\\b.’ In line seven, the word ‘foo’ is indicated as a stop word.

Other examples of analysis type parameter values include values for processing textual data in accordance with one or more delimiters and values for normalizing textual data, e.g., normalizing data according to a common standard, format, representation, or value. One example use of an analysis type parameter value for normalization can be to normalize text to a common value, where the text may have different Unicode/ASCII representations. In some examples, the analysis type parameter value can include a ‘no-op’ parameter value. A no-op analysis may be chosen to cause a search index to be generated storing text as-is, without additional processing or analysis. One example use of the no-op analysis is for searching for unique identifiers or hash values from a body of text containing only identifiers or hash values, where no additional processing or analysis is necessary.

As another example, the textual analysis function can also be called with other parameters, such as delimiters for the target data, or parameters for normalizing the data. Returning to FIG. 1, the specification shown in TABLE 1 can be processed by either the search sub-system 115 or the machine learning pre-processing sub-system 110. If the specification is processed by the search sub-system 115, the search sub-system 115 can be configured to generate, for example, a set of tokens in accordance with the predetermined pattern, the stop word, and the target data set (‘O Foo Bar’). If the specification is processed by the machine learning pre-processing sub-system 110, the sub-system 110 can be configured to, for example, vectorize the target data set after filtering words in accordance with the pattern and stop word.

TABLE 2 shows an example of a search query operation using the specification shown in TABLE 1.

TABLE 2

| | |
|---|---|
| 1 | SELECT * FROM my_table( |
| 2 | WHERE SEARCH( |
| 3 | column1, |
| 4 | ‘bar’, |
| 5 | [Specification] |
| 6 | ) |
| 7 | ) |

Line one includes a selection statement to select all values from a table called my_table, subject to the search parameters of lines two through five. Line three targets the column called column1, and ‘bar’ is the target of the search query. [Specification] is the specification as shown in TABLE 1. A search sub-system receiving this query is configured to process the column data in column1 to return results of ‘bar.’

TABLE 3 shows an example of a command to perform a search index generation operation using the specification shown in TABLE 1.

TABLE 3

| | |
|---|---|
| 1 | CREATE SEARCH INDEX my_index ON |
| | my_table(ALL COLUMNS) |
| 2 | OPTIONS ( |
| 3 | [Specification] |
| 4 | ) |
| 5 | ) |

Line three includes a create search index function called my_index over a table called my_table, with all columns selected. Lines two through three provide options for creating the search index. In line three, [Specification] is the portion of the specification defined as shown in TABLE 1 and is used as parameters for generating a search index for the table my_table.

TABLE 4 shows an example of a command to pre-process data before training a machine learning model using the specification shown in TABLE 1.

TABLE 4

| | |
|---|---|
| 1 | TEXT.TFIDF(TEXT.ANALYZE(input_string, |
| | [specification])) |

Line one of TABLE 4 includes a TFIDF function call, a statistical process function, which when executed causes the DBMS to perform the operations of taking input text data and the [specification] as in TABLE 1 and creating a vector of numerical values using term frequency-inverse document frequency (TF-IDF). The input string is the target data for the specification, in this example. The output of the TFIDF function can be a vector of numbers. In the search context, a search sub-system can use the TFIDF function call and the specification to perform a sort operation to sort search results, together with a distance metric, such as cosine distance. As another example, the search sub-system can use the TFIDF function to generate a search index for the target data, for example based on the numerical values generated for words in the target data.

As another example, other statistical process functions can cause operations to be executed on the target data in accordance with the specification. For example, either the search sub-system 115 or the ML pre-processing sub-system 110 can implement a distance function, e.g., a cosine distance function, a Euclidean distance function, and/or a Levenshtein distance function and perform a respective distance calculation. The distances between vector representations of different elements in a target data set can be used for comparing the similarity of different elements. The calculated distance values may become search criteria in a search context, e.g., for searching for other elements in a target data set that are within a threshold distance of an input element. The calculated distance values may become features in an ML pre-processing context, e.g., for enhancing training data with additional features before being used to train a machine learning model.

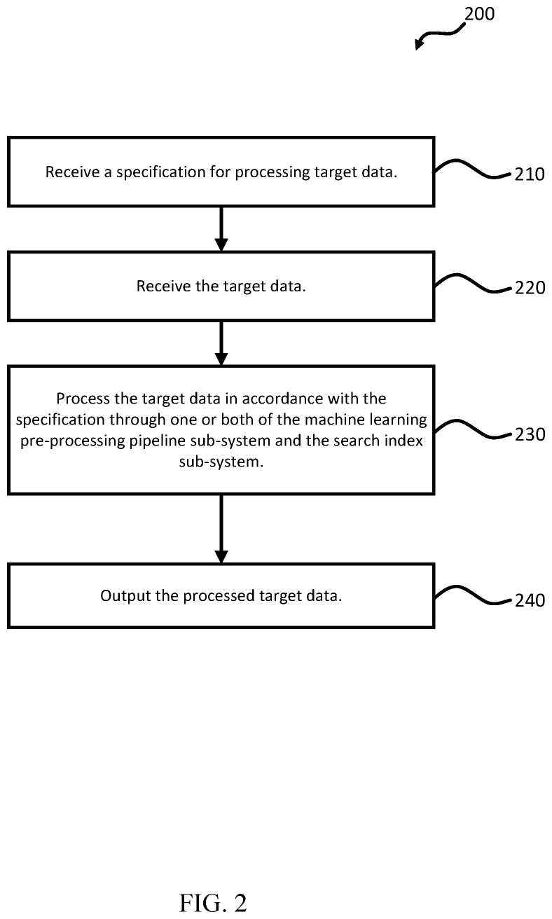

FIG. 2 is a flow diagram of an example process 200 for performing search indexing and machine learning pre-processing using the same user specification, according to aspects of the disclosure. The example process can be performed on a system of one or more processors in one or more locations, such as the DBMS 100 of FIG. 1.

The DBMS receives a specification for processing target data, according to block 210. The specification can be part of a request received by the DBMS, for example from a user computing device. The specification and the request can be formatted in SQL or another programming or scripting language. In some examples, the request can be received as natural language, which can be written or provided over video, images, audio, or any other modality.

The machine learning pre-processing sub-system can be configured to execute one or more machine learning pre-processing operations associated with the pre-processing function call, and the search sub-system is configured to execute one or more search operations different from the one or more machine learning pre-processing operations and associated with the pre-processing function call.

The one or more machine learning pre-processing operations can include one or more operations for performing a text vectorization of the target data, wherein the target data is vectorized in accordance with the specification. The one or more search operations can include one or more operations for generating one or more tokens of text from the target data and generating a search index for the one or more tokens of text. How the tokens are generated is in accordance with the specification and any corresponding parameter values.

The specification can include an analysis type parameter value specifying a type of analysis to perform. The one or more machine learning pre-processing operations include one or more operations for filtering the target data in accordance with the type of pattern recognition specified, before performing the text vectorization on the target data, and the one or more search operations include one or more operations for filtering the target data in accordance with the type of textual analysis specified, before generating the search index. A pattern recognition parameter value can include a regular expression representing a pattern for parsing the target data. In some examples, specification includes a statistical process parameter value specifying a type of statistical process to perform. Other examples include a delimiter parameter value for splitting the text into tokens using one or more specified delimiters.

The DBMS receives the target data, according to block 220. The target data can be retrieved automatically or in response to a request that includes the specification. For example, the request can be a search query specifying target data from one or more databases managed by the DBMS or another source. In some examples, the target data may be predetermined based on the source of the request that includes the specification or predetermined based on earlier input provided to the DBMS that identifies the target data. The target data can be text data.

The DBMS processes the target data in accordance with the specification through one or both of the machine learning pre-processing sub-system and the search sub-system, according to block 230. In processing the target data, the machine learning pre-processing sub-system and the search sub-system are configured to receive the specification and execute different operations using the specification. In some examples, operations between the sub-systems may overlap, for example, operations for normalizing text or other pre-processing may be performed by either the machine learning pre-processing sub-system or the search sub-system.

The DBMS at can least partially implements a machine learning pre-processing sub-system and a search sub-system. For example, the machine learning pre-processing sub-system can be the machine learning pre-processing sub-system 110 and the search sub-system 115 as shown and described in FIG. 1. The DBMS can implement the sub-systems using one or more processors, devices, engines, etc., configured for performing operations corresponding to search or machine learning pre-processing, respectively. Example operations include operations for searching, generating a search index, and pre-processing machine learning training data for executing or training a model. In some examples, the DBMS can partially implement the sub-systems by implementing at least part of a respective interface for managing input and output to the sub-systems. In those examples, the sub-systems may be implemented on devices that are not logically or physically part of the devices, processors, engines, etc., implementing the DBMS.

In some examples, the machine learning pre-processing sub-system is configured to perform data pre-processing operations using the specification, for example to execute or train a machine learning model. The search sub-system can be configured to pre-process the target data using the specification, as an example of generating a search index for the pre-processed target data.

In some examples, the one or more machine learning pre-processing operations can include one or more operations for generating statistical data from the target data by performing the specified type of statistical process, and the one or more search operations include one or more operations for generating the search index based on the generated statistical data. The type of statistical process can be a bag of words frequency calculation, a term frequency-inverse document frequency (TF-IDF) calculation, a cosine distance calculation, a Euclidean distance calculation, and/or a Levenshtein distance calculation.

The DBMS outputs the processed target data, according to block 240. The processed target data can be output to a user computing device, for example a device that sends a request to process the target data with a specification. The processed target data can also be stored in the DBMS, and/or sent to other components or devices, either of the DBMS or external to the DBMS.

For example, the processed target data can be sent to one or more devices implementing a machine learning pipeline, as shown, and described with reference to the ML processing pipeline 150. In some examples, The DBMS can train or execute a machine learning model using the processed target data. The DBMS can receive a search query on the target data and generate search results responsive to the search query using the generated search index. Implementations of the present technology include, but are not limited to, the following:
(1) A method performed by one or more processors, including: receiving the target data; processing the target data in accordance with the specification through one or both of a machine learning pre-processing sub-system and a search sub-system, wherein the target data, the machine learning pre-processing sub-system and the search sub-system are configured to receive the specification and execute different operations using the specification; and outputting the processed target data.
(2) The method of (1), wherein: the machine learning pre-processing sub-system is configured to: perform data pre-processing operations using the specification, and the search sub-system is configured to: pre-process the target data using the specification and generating a search index for the pre-processed target data.
(3) The method of (1) or (2), wherein: the machine learning pre-processing sub-system is configured to execute one or more machine learning pre-processing operations using the specification, and the search sub-system is configured to execute one or more search operations different from the one or more machine learning pre-processing operations and using the specification.
(4) The method of (3), wherein: the one or more machine learning pre-processing operations include one or more operations for performing a text vectorization of the target data, wherein the target data is vectorized in accordance with the specification, and the one or more search operations include one or more operations for generating one or more tokens of text from the target data, and generating a search index for the one or more tokens of text, wherein the one or more tokens of text are generated in accordance with the specification.
(5) The method of (4), wherein the method further includes: receiving a search query on the target data; and generating search results responsive to the search query using the generated search index.
(6) The method of (4) or (5), wherein: the specification comprises an analysis type parameter value, the one or more machine learning pre-processing operations include one or more operations for filtering the target data in accordance with the analysis type parameter value, before performing the text vectorization on the target data, and the one or more search operations include one or more operations for filtering the target data in accordance with the analysis type parameter value, before generating the search index.
(7) The method of (6), wherein the analysis type parameter value is at least one of a pattern recognition parameter value for executing a pattern recognition function; and a normalization parameter value for normalizing the text to a common standard, format, or value; a no-op parameter value for performing no analysis or processing on the text; or a delimiter parameter value for splitting the text into tokens using one or more specified delimiters.
(8) The method of (6) or (7), wherein: the target data includes text data, and the pattern recognition parameter value further includes a regular expression.
(9) The method of any one of (4) through (8), wherein: the specification includes a statistical process parameter value specifying a type of statistical process, the one or more machine learning pre-processing operations include one or more operations for generating statistical data from the target data by performing the specified type of statistical process, and the one or more search operations include one or more operations for generating the search index based on the generated statistical data.
(10) The method of (9), wherein the type of statistical process is at least one of: a bag of words frequency calculation, a term frequency-inverse document frequency (TF-IDF) calculation, a cosine distance calculation, a Euclidean distance calculation, or a Levenshtein distance calculation.
(11) The method of any one of (1) through (10), wherein the method further includes: training or executing a machine learning model using the processed target data.
(12) The method of any one of (1) through (11), wherein the method further includes at least partially implementing the machine learning pre-processing sub-system, the search sub-system, or both the machine learning pre-processing sub-system and the search sub-system.
(13) The method of any one of (1) through (12), wherein the machine learning pre-processing system and the search sub-system are configured to perform one or more overlapping operations.
(14) The method of any one of (1) through (13), wherein the specification is part of a structured query language (SQL) statement.
(15) A system, including one or more processors configured to perform the operations of the method of any one of (1)-(14).
(16) One or more non-transitory computer-readable storage media storing instructions that are operable, when executed by one or more processors, to cause the one or more processors to perform operations as in any one of (1)-(14).

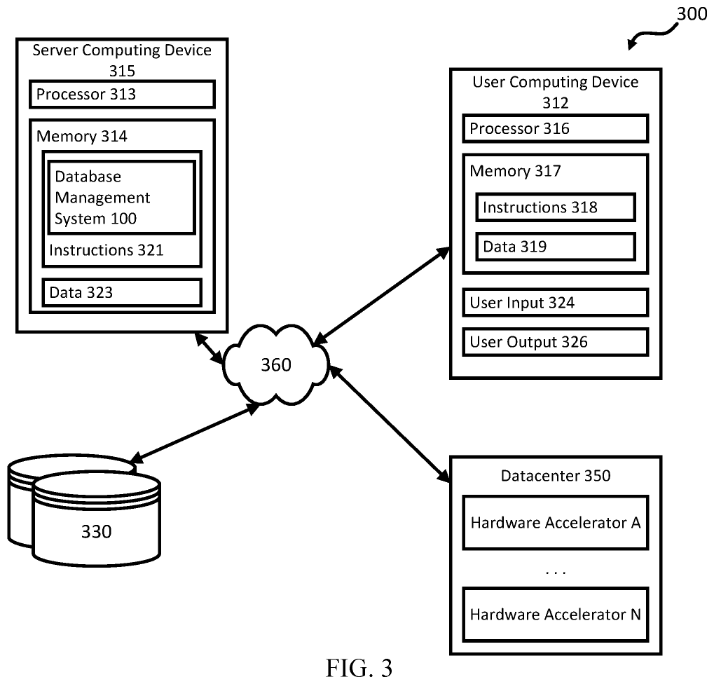

FIG. 3 is a block diagram of an example computing environment 300 for implementing the DBMS 100. The DBMS 100 can be implemented on one or more devices having one or more processors in one or more locations, such as in server computing device 315. User computing device 312 and the server computing device 315 can be communicatively coupled to one or more storage devices 330 over a network 360. The storage device(s) 330 can be a combination of volatile and non-volatile memory and can be at the same or different physical locations than the computing devices 312, 315. For example, the storage device(s) 330 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 315 can include one or more processors 313 and memory 314. The memory 314 can store information accessible by the processor(s) 313, including instructions 321 that can be executed by the processor(s) 313. The memory 314 can also include data 323 that can be retrieved, manipulated or stored by the processor(s) 313. The memory 314 can be a type of non-transitory computer readable medium capable of storing information accessible by the processor(s) 313, such as volatile and non-volatile memory. The processor(s) 313 can include one or more central processing units (CPUs), graphic processing units (GPUs), field-programmable gate arrays (FPGAs), and/or application-specific integrated circuits (ASICs), such as tensor processing units (TPUs).

The instructions 321 can include one or more instructions that when executed by the processor(s) 313, causes the one or more processors to perform actions defined by the instructions. The instructions 321 can be stored in object code format for direct processing by the processor(s) 313, or in other formats including interpretable scripts or collections of independent source code modules that are interpreted on demand or compiled in advance. The instructions 321 can include instructions for implementing the DBMS 100 consistent with aspects of this disclosure. The DBMS 100 can be executed using the processor(s) 313, and/or using other processors remotely located from the server computing device 315.

The data 323 can be retrieved, stored, or modified by the processor(s) 313 in accordance with the instructions 321. The data 323 can be stored in computer registers, in a relational or non-relational database as a table having a plurality of different fields and records, or as JSON, YAML, proto, or XML documents. The data 323 can also be formatted in a computer-readable format such as, but not limited to, binary values, ASCII or Unicode. Moreover, the data 323 can include information sufficient to identify relevant information, such as numbers, descriptive text, proprietary codes, pointers, references to data stored in other memories, including other network locations, or information that is used by a function to calculate relevant data.

The user computing device 312 can also be configured similarly to the server computing device 315, with one or more processors 316, memory 317, instructions 318, and data 319. The user computing device 312 can also include a user output 326, and a user input 324. The user input 324 can include any appropriate mechanism or technique for receiving input from a user, such as keyboard, mouse, mechanical actuators, soft actuators, touchscreens, microphones, and sensors.

The server computing device 315 can be configured to transmit data to the user computing device 312, and the user computing device 312 can be configured to display at least a portion of the received data on a display implemented as part of the user output 326. The user output 326 can also be used for displaying an interface between the user computing device 312 and the server computing device 315. The user output 326 can alternatively or additionally include one or more speakers, transducers or other audio outputs, a haptic interface or other tactile feedback that provides non-visual and non-audible information to the platform user of the user computing device 312.

Although FIG. 3 illustrates the processors 313, 316 and the memories 314, 317 as being within the computing devices 315, 312, components described in this specification, including the processors 313, 316 and the memories 314, 317 can include multiple processors and memories that can operate in different physical locations and not within the same computing device. For example, some of the instructions 321, 318 and the data 323, 319 can be stored on a removable SD card and others within a read-only computer chip. Some or all of the instructions and data can be stored in a location physically remote from, yet still accessible by, the processors 313, 316. Similarly, the processors 313, 316 can include a collection of processors that can perform concurrent and/or sequential operation. The computing devices 315, 312 can each include one or more internal clocks providing timing information, which can be used for time measurement for operations and programs run by the computing devices 315, 312.

The server computing device 315 can be configured to receive requests to process data from the user computing device 312. For example, the environment 300 can be part of a computing platform configured to provide a variety of services to users, through various user interfaces and/or APIs exposing the platform services. One or more services can be a machine learning framework or a set of tools for generating neural networks or other machine learning models according to a specified task and training data. The user computing device 312 may receive and transmit data specifying target computing resources to be allocated for executing a neural network trained to perform a particular neural network task.

The devices 312, 315 can be capable of direct and indirect communication over the network 360. The devices 315, 312 can set up listening sockets that may accept an initiating connection for sending and receiving information. The network 360 itself can include various configurations and protocols including the Internet, World Wide Web, intranets, virtual private networks, wide area networks, local networks, and private networks using communication protocols proprietary to one or more companies. The network 360 can support a variety of short-and long-range connections. The short-and long-range connections may be made over different bandwidths, such as 2.402 GHz to 2.480 GHz (commonly associated with the Bluetooth® standard), 2.4 GHz and 5 GHz (commonly associated with the Wi-Fi® communication protocol); or with a variety of communication standards, such as the LTE® standard for wireless broadband communication. The network 360, in addition or alternatively, can also support wired connections between the devices 312, 315, including over various types of Ethernet connection.

Datacenter 350 can be connected to the server computing device 315 and the user computing device 312 over the network 360. In some examples, the datacenter 350 can house the server computing device 315. The datacenter 350 can include hardware accelerators A-N. A hardware accelerator can be any type of processor, such as a CPU, GPU, FPGA, or ASIC such as a tensor processing unit (TPU).

The hardware accelerators A-N can be used as part of performing operations corresponding to the ML pre-processing sub-system and the ML processing pipeline of the DBMS 100.

The DBMS 100 can be configured to execute or train one or more artificial intelligence (AI) models corresponding to one or more architectures. An architecture of a model can refer to characteristics defining the model, such as characteristics of layers for the model, how the layers process input, or how the layers interact with one another. For example, the model can be a convolutional neural network that includes a convolution layer that receives input data, followed by a pooling layer, followed by a fully connected layer that generates a result. The architecture of the model can also define types of operations performed within each layer. For example, the architecture of a convolutional neural network may define that rectified linear unit (ReLU) activation functions are used in the fully connected layer of the network. One or more model architectures can be generated that can output results associated with executing operations for the ML processing pipeline and/or the ML pre-processing sub-system.

The machine learning models can be trained according to a variety of different learning techniques. Learning techniques for training the machine learning models can include supervised learning, unsupervised learning, semi-supervised learning, and reinforcement learning techniques. For example, training data can include multiple training examples that can be received as input by a model. The training examples can be labeled with a desired output for the model when processing the labeled training examples. The label and the model output can be evaluated through a loss function to determine an error, which can be backpropagated through the model to update weights for the model. For example, a supervised learning technique can be applied to calculate an error between outputs, with a ground-truth label of a training example processed by the model.

Any of a variety of loss or error functions appropriate for the type of the task the model is being trained for can be utilized, such as cross-entropy loss for classification tasks, or mean square error for regression tasks. The gradient of the error with respect to the different weights of the candidate model on candidate hardware can be calculated, for example using a backpropagation algorithm, and the weights for the model can be updated. The model can be trained until stopping criteria are met, such as a number of iterations for training, a maximum period of time, a convergence, or when a minimum accuracy threshold is met.

As described herein, aspects of the disclosure provide for pre-processing training or input data for performing a machine learning task. Examples of machine learning tasks follow.

As an example, the input to the machine learning model can be in the form of images, videos. A machine learning model can be configured to extract, identify, and generate features as part of processing a given input, for example as part of a computer vision task. A machine learning model trained to perform this type of machine learning model task can be trained to generate an output classification from a set of different potential classifications. In addition, or alternatively, the machine learning model can be trained to output a score corresponding to an estimated probability that an identified subject in the image or video belongs to a certain class.

As another example, the input to the machine learning model can be data files corresponding to a particular format, e.g., HTML files, word processing documents, or formatted metadata obtained from other types of data, such as metadata for image files. A machine learning model task in this context can be to classify, score, or otherwise predict some characteristic about the received input. For example, a machine learning model can be trained to predict the probability received input includes text relating to a particular subject. Also, as part of performing a particular task, the machine learning model can be trained to generate text predictions, for example as part of a tool for auto-completion of text in a document as the document is being composed. A machine learning model can also be trained for predicting a translation of text in an input document to a target language, for example as a message is being composed.

Other types of input documents can be data relating to characteristics of a network of interconnected devices. These input documents can include activity logs, as well as records concerning access privileges for different computing devices to access different sources of potentially sensitive data. A machine learning model can be trained for processing these and other types of documents for predicting on-going and future security breaches to the network. For example, the machine learning model can be trained to predict intrusion into the network by a malicious actor.

As another example, the input to a machine learning model can be audio input, including streamed audio, pre-recorded audio, and audio as part of a video or other source or media. A machine learning model task in the audio context can include speech recognition, including isolating speech from other identified sources of audio and/or enhancing characteristics of identified speech to be easier to hear. A machine learning model can be trained to predict an accurate translation of input speech to a target language, for example in real-time as part of a translation tool.

In addition to data input, including the various types of data described herein, a machine learning model can also be trained to process features corresponding to given input. Features are values, e.g., numerical or categorical, which relate to some characteristic of the input. For example, in the context of an image, a feature of the image can relate to the RGB value for each pixel in the image. A machine learning model task in the image/video context can be to classify contents of an image or video, for example for the presence of different people, places, or things. Machine learning models can be trained to extract and select relevant features for processing to generate an output for a given input and can also be trained to generate new features based on learned relationships between various characteristics of input data.

Although a single server computing device 315, user computing device 312, and datacenter 350 are shown in FIG. 3, it is understood that the aspects of the disclosure can be implemented according to a variety of different configurations and quantities of computing devices or virtual machines, including in paradigms for sequential or parallel processing, or over a distributed network of multiple devices. In some implementations, aspects of the disclosure can be performed on a single device, and any combination thereof.

Aspects of this disclosure can be implemented in digital electronic circuitry, in tangibly-embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, that is generated to encode information for transmission to suitable receiver apparatus for execution by a data processing apparatus.

The term “configured” is used herein in connection with systems and computer program components. For a system of one or more computers to be configured to perform particular operations or actions means that the system has installed software, firmware, hardware, or a combination thereof that cause the system to perform the operations or actions. For one or more computer programs to be configured to perform operations or actions means that the one or more programs include instructions that, when executed by one or more data processing apparatus, cause the apparatus to perform the operations or actions.

The term “data processing apparatus” refers to data processing hardware and encompasses various apparatus, devices, and machines for processing data, including programmable processors, a computer, or combinations thereof. The data processing apparatus can include special purpose logic circuitry, such as a field programmable gate array (FPGA) or an application specific integrated circuit (ASIC), such as a Tensor Processing Unit (TPU). The data processing apparatus can include code that creates an execution environment for computer programs, such as code that constitutes processor firmware, a protocol stack, a database management system, an operating system, or combinations thereof.

The data processing apparatus can include special-purpose hardware accelerator units for implementing machine learning models to process common and compute-intensive parts of machine learning training or production, such as inference or workloads. Machine learning models can be implemented and deployed using one or more machine learning frameworks, such as static or dynamic computational graph frameworks.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a standalone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently. A database management system can be implemented by one or more processors in one or more locations, and be configured to manage repositories of data organized, for example, as databases. A database management system can be configured to receive queries, parse the queries, and return data responsive to the query.

The term “engine” refers to a software-based system, subsystem, or process that is programmed to perform one or more specific functions. The engine can be implemented as one or more software modules or components or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purpose logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions.

The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back-end component, e.g., as a data server, a middleware component, e.g., an application server, or a front-end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the implementations should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A system comprising:
one or more processors configured to:
receive a specification for processing target data;
receive the target data;
process the target data in accordance with the specification through one or both of a machine learning pre-processing sub-system and a search sub-system, wherein the machine learning pre-processing sub-system and the search sub-system are configured to receive the specification and execute different operations using the specification; and
output the processed target data.

2. The system of claim 1, wherein:
the machine learning pre-processing sub-system is configured to:
perform data pre-processing operations using the specification, and the search sub-system is configured to:
pre-process the target data using the specification, and
generate a search index for the pre-processed target data.

3. The system of claim 1, wherein:
the machine learning pre-processing sub-system is configured to execute one or more machine learning pre-processing operations using the specification, and
the search sub-system is configured to execute one or more search operations different from the one or more machine learning pre-processing operations and using the specification.

4. The system of claim 3, wherein:
the one or more machine learning pre-processing operations comprise one or more operations for performing a text vectorization of the target data, wherein the target data is vectorized in accordance with the specification, and
the one or more search operations comprise one or more operations for generating one or more tokens of text from the target data, and generating a search index for the one or more tokens of text, wherein the one or more tokens of text are generated in accordance with the specification.

5. The system of claim 4, wherein the one or more processors are further configured to:
receive a search query on the target data; and
generate search results responsive to the search query using the generated search index.

6. The system of claim 4, wherein:
the specification comprises an analysis type parameter value,
the one or more machine learning pre-processing operations comprise one or more operations for filtering the target data in accordance with the analysis type parameter value, before performing the text vectorization on the target data, and
the one or more search operations comprise one or more operations for filtering the target data in accordance with the analysis type parameter value, before generating the search index.

7. The system of claim 6, wherein the analysis type parameter value is at least one of:
a pattern recognition parameter value for executing a pattern recognition function;
a normalization parameter value for normalizing the text to a common standard, format, or value;
a no-op parameter value for performing no analysis or processing on the text; or
a delimiter parameter value for splitting the text into tokens using one or more specified delimiters.

8. The system of claim 7, wherein:
the target data comprises text data, and
the pattern recognition parameter value further comprises a regular expression.

9. The system of claim 4, wherein:
the specification comprises a statistical process parameter value specifying a type of statistical process,
the one or more machine learning pre-processing operations comprise one or more operations for generating statistical data from the target data by performing the specified type of statistical process, and
the one or more search operations comprise one or more operations for generating the search index based on the generated statistical data.

10. The system of claim 9, wherein the type of statistical process is at least one of:
a bag of words frequency calculation,
a term frequency-inverse document frequency (TF-IDF) calculation,
a cosine distance calculation,
a Euclidean distance calculation, or
a Levenshtein distance calculation.

11. The system of claim 1, wherein the one or more processors are further configured to:
train or execute a machine learning model using the processed target data.

12. The system of claim 1, wherein the specification is part of a structured query language (SQL) statement.

13. The system of claim 1, wherein the machine learning pre-processing system and the search sub-system are configured to perform one or more overlapping operations.

14. A method, comprising:
receiving, by the one or more processors, a specification for processing target data;
receiving, by the one or more processors, the target data;
processing, by the one or more processors, the target data in accordance with the specification through one or both of a machine learning pre-processing sub-system and a search sub-system, wherein the machine learning pre-processing sub-system and the search sub-system are configured to receive the specification and execute different operations using the specification; and
outputting, by the one or more processors, the processed target data.

15. The method of claim 14, wherein the method further comprises:
when the target data is processed through the machine learning pre-processing sub-system,
performing data pre-processing operations using the specification; and
when the target data is processed through the search sub-system,
pre-processing the target data using the specification, and
generating a search index for the pre-processed target data.

16. The method of claim 15, wherein:
the machine learning pre-processing sub-system is configured to execute one or more machine learning pre-processing operations, and
the search sub-system is configured to execute one or more search operations different from the one or more machine learning pre-processing operations using the specification.

17. The method of claim 16, wherein:
the one or more machine learning pre-processing operations comprise one or more operations for performing a text vectorization of the target data, wherein the target data is vectorized in accordance with the specification, and
the one or more search operations comprise one or more operations for generating one or more tokens of text from the target data, and generating a search index for the one or more tokens of text, wherein the one or more tokens of text are generated in accordance with the specification.

18. The method of claim 17, wherein:
the specification comprises an analysis type parameter value,
the one or more machine learning pre-processing operations comprise one or more operations for filtering the target data in accordance with the analysis type parameter value, before performing the text vectorization on the target data, and
the one or more search operations comprise one or more operations for filtering the target data in accordance with the analysis type parameter value, before generating the search index.

19. The method of claim 18, wherein:
the target data comprises text data, and
the pattern recognition parameter value further comprises a regular expression.

20. One or more non-transitory computer-readable storage media storing instructions that operable when performed by one or more processors, to cause the one or more processors to perform operations comprising:
receiving a specification for processing target data;
receiving the target data;
processing the target data in accordance with the specification through one or both of a machine learning pre-processing sub-system and a search sub-system, wherein the machine learning pre-processing sub-system and the search sub-system are configured to receive the specification and execute different operations using the specification; and
outputting the processed target data.
